(19) United States
(12) Patent Application Publication
(10) Pub. No.: US 2022/0118475 A1
(43) Pub. Date: Apr. 21, 2022

(54) Painting Roller Frame Device

(71) Applicant: Martha Manchester, Edgecomb, ME (US)

(72) Inventor: Martha Manchester, Edgecomb, ME (US)

(21) Appl. No.: 17/396,864

(22) Filed: Aug. 9, 2021

Related U.S. Application Data
(60) Provisional application No. 63/093,466, filed on Oct. 19, 2020.

(51) Int. Cl. B05C 17/02

(52) U.S. Cl. CPC B05C 17/0217; B05C 17/022; B05C 17/0205

(57) ABSTRACT

A roller frame device that is adapted to hold a paint roller in one or more positions, at least one of which is in an approximately vertical orientation.

### FIELD OF THE INVENTION

The invention relates to paint rollers and, in particular, frames for roller devices that are used to paint relatively large and relatively flat surfaces.

### DISCUSSION OF PRIOR ART

A paint roller is a device that is commonly used for painting large flat surfaces rapidly and efficiently. Each roller commonly includes two parts: a roller frame; and a roller cover. The roller cover absorbs paint and is used to transfer the paint to a surface. The roller frame is a ridged component that is held by the painter and attaches to the roller cover, such that the painter uses the roller frame to transfer the paint from the roller cover to the surface.

The frame commonly includes a handle that is vertically oriented and that has an extension arm that extends outward and away from the handle and bends in a manner that supports the roller cover in a horizontal manner such that the roller cover is perpendicular to the handle. This configuration enables painters to apply paint to the majority of the surface in an ergonomic manner.

However, the conventional paint roller is not suitable for applying paint to the upper or lower edges of a surface, such as the areas between a wall and a ceiling, or between a wall and a floor or baseboard, or between the exterior trim and the roof. In these instances, if a user were to attempt to apply paint in the normal course it is likely that paint would be applied to the ceiling and/or floor while leaving a gap in the upper area of the wall.

What is needed, therefore, is a paint roller that is able to conveniently apply paint to upper and lower boundaries of a surface.

### BRIEF SUMMARY OF THE INVENTION

The invention is a paint roller frame that is configured to hold a roller cover in multiple orientations and, in one preferred embodiment, secures the roller cover in an approximately vertical orientation. When the roller frame is configured in this preferred embodiment it enables a user, i.e. a painter, to paint upper and lower boundaries of a surface, such as a wall, in an quick, ergonomic, and effective manner.

The paint roller frame may be adjustable such that the roller cover may be set in a vertical orientation, a traditional horizontal orientation, or in a number of different angled orientations. The roller frame is constructed in two components, a handle and a roller arm that are adjustably coupled to one another. An adjustment member enables a painter to fix the roller arm in the desired orientation and then to release the fixed connection and move the roller arm to a different orientation when needed.

### BRIEF DESCRIPTION OF THE DRAWINGS

The present invention is described with reference to the accompanying drawings. In the drawings, like reference numbers indicate identical or functionally similar elements. The drawings are not drawn to scale.

FIG. 1 is a top plan view of the roller frame according to the invention in a vertical painting orientation with a roller cover.

FIG. 2 is a top plan view of the roller frame with a roller cover, the roller cover in an angled orientation.

FIG. 3 is a top plan view of the roller frame with a roller cover, the roller cover in an traditional horizontal orientation.

FIG. 4 is a top plan view of the roller frame without a roller cover.

FIG. 5 is a top plan view of the arm that holds the roller cover.

FIG. 6 is a top plan view of a portion of the arm that holders the roller cover with a close view of a portion of the adjustment mechanism.

FIG. 7 is a top plan view of the roller frame showing a close view of the adjustment mechanism's securing means.

FIG. 8 is a top plan view of the roller frame showing a close view of the adjustment mechanism's securing means.

FIG. 9 is a rear view of the adjustment mechanism with the adjustment arm secured in a horizontal position.

FIG. 10 is a rear view of the adjustment mechanism without the adjustment arm.

FIG. 11 is a front view of the device with the arm extended in a vertical direction and a close view of the adjustment mechanism.

FIG. 12 is a close view of the adjustment mechanism.

FIG. 13 is a view of the securing means.

FIG. 14 is an embodiment of the invention in a vertical orientation without the adjustment means.

### DETAILED DESCRIPTION OF THE INVENTION

The present invention will now be described more fully in detail with reference to the accompanying drawings, in which the preferred embodiments of the invention are shown. This invention should not, however, be construed as limited to the embodiments set forth herein; rather, they are provided so that this disclosure will be complete and will fully convey the scope of the invention to those skilled in the art.

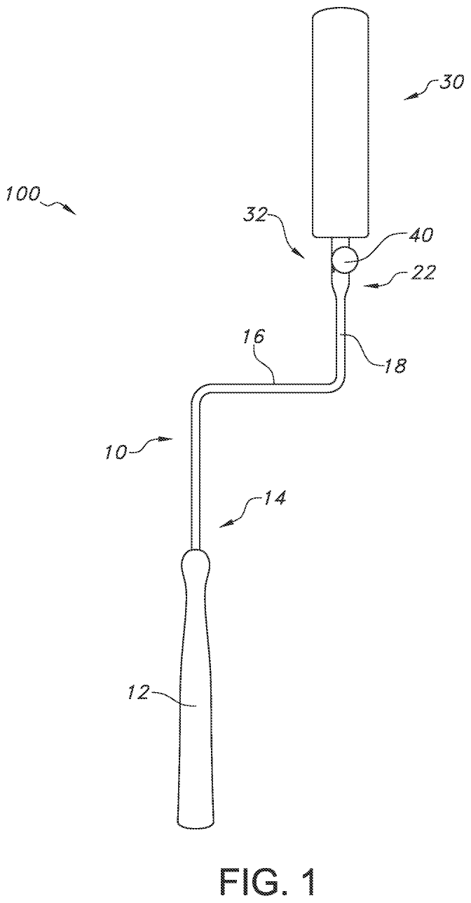

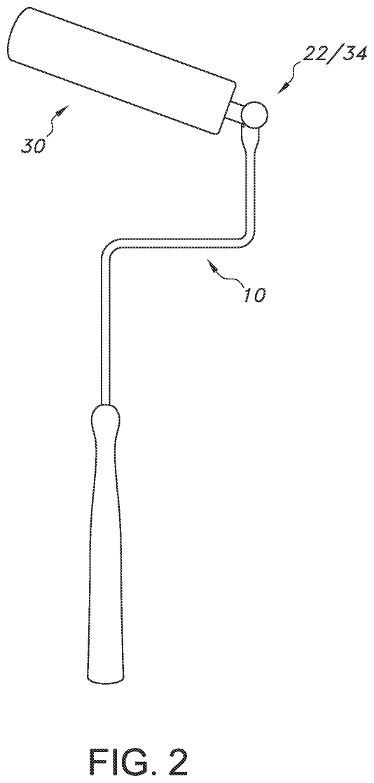

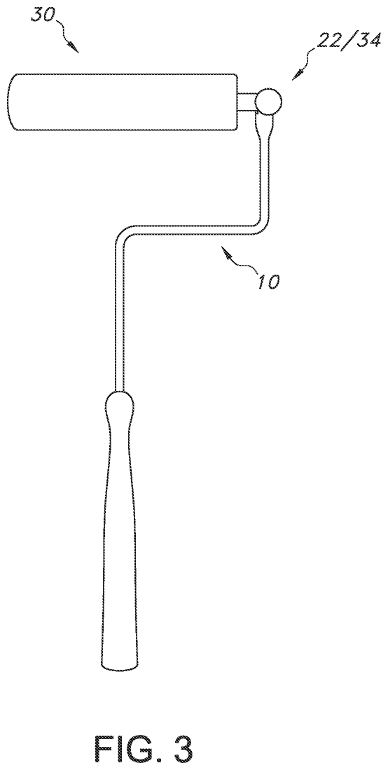

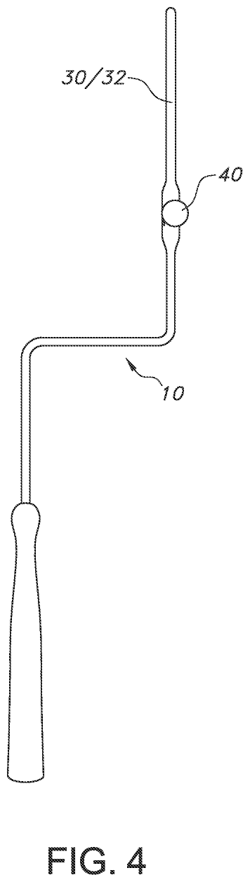

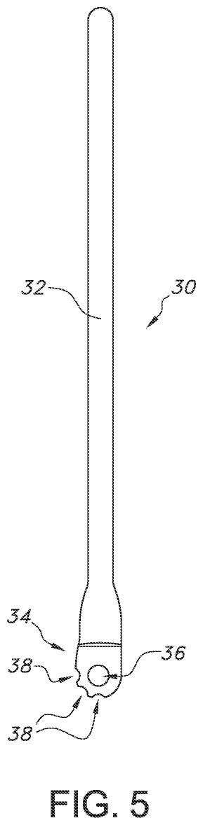

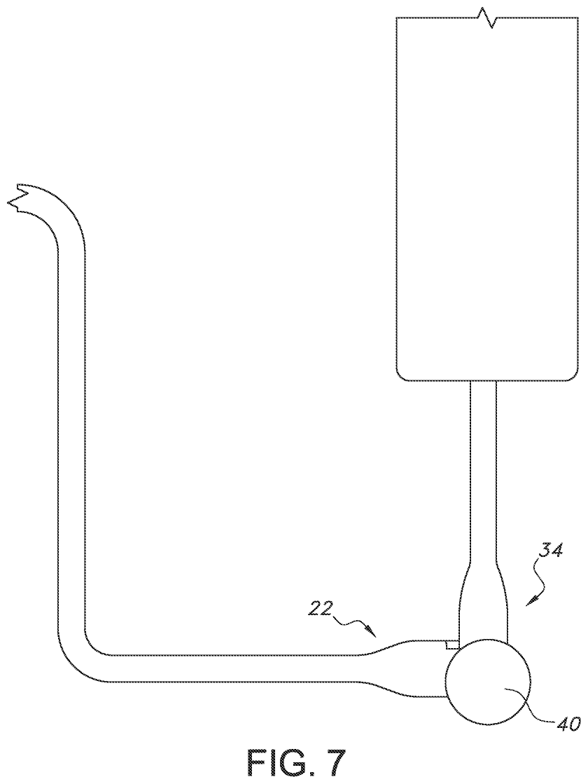

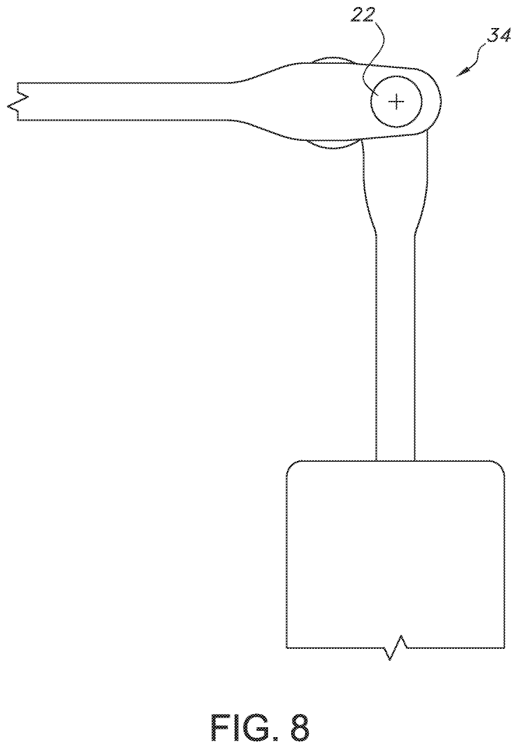

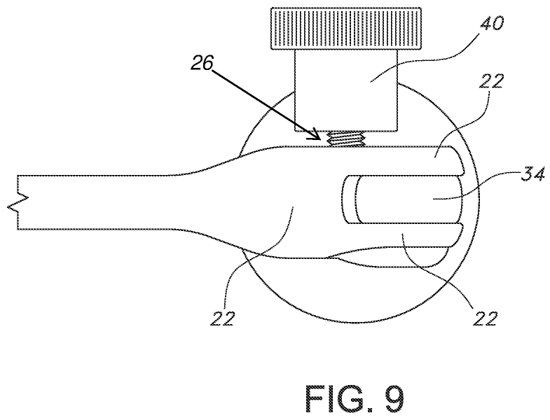

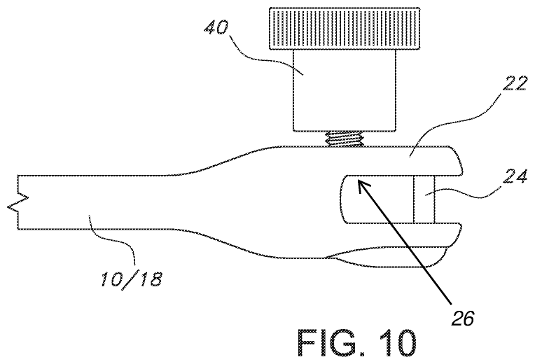

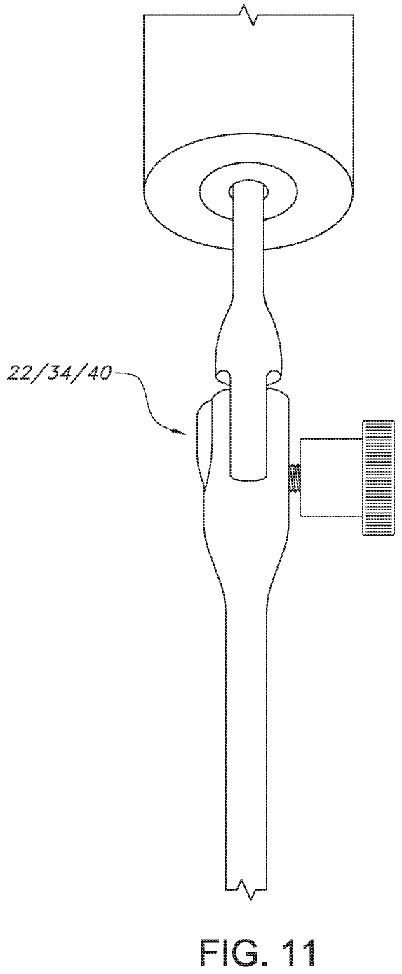

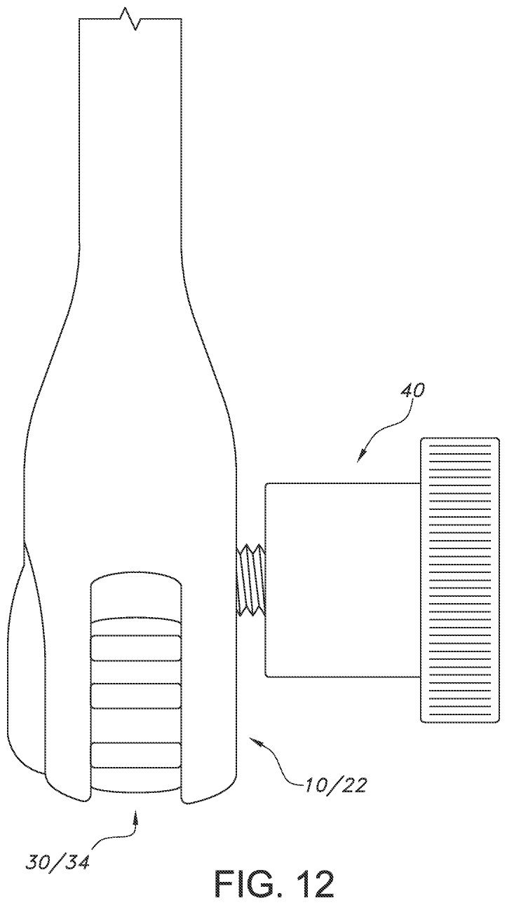

FIGS. 1-13 illustrate the first embodiment of the roller frame device 100 according to the invention that is configured to hold a roller cover C in a number of different orientations, including an approximately vertical orientation so that a painter may easily and ergonomically paint along an upper and/or lower edge flat surface. The design is particularly advantageous for use in painting upper and/or lower portions of walls or exterior trim of a building structure, where a painter may use a conventional roller orientation to paint the central portion of the walls/trim and then use the vertical orientation to precisely paint along the edges using the roller frame device 100 while continuing to hold the roller in the conventional, ergonomically correct, and comfortable manner. Other angled orientations are also enabled to assist a painter in other painting scenarios.

The roller frame device 100 includes a handle 10 and a roller cover arm, or roller arm, 30. As noted, in one example the roller frame device 100 is configured to hold the roller cover C in an approximately vertical or vertical orientation, and in this manner both the handle 10 and the roller arm 30 that secures the roller cover C have a similar orientation such that when a painter grips the handle 10 for painting both the handle 10 and roller cover C are pointed in an approximately vertical direction/orientation.

The handle 10 likely has a section that is similar to a conventional paint roller handle and that is comfortably gripped by a painter. The roller cover arm 30 is configured to securely hold a roller cover C in a conventional manner, holding the roller cover C in a secure orientation while allowing the roller cover C to spin 360 degree about a center axis. The roller cover C is likely to be held apart from the handle by some reasonable distance, likely 2 to 4 inches, so that the painter's hand may be spaced apart from the surface that is being painted while still allowing the painter to exert the necessary amount of force and control of the roller frame device 100. The exact manner of construction of the handle 10 and roller cover arm 30 may vary in a number of conventional manners.

The handle 10 may include a grip section 12 that is sized and shaped to be comfortably held by a conventional user such as a painter. For example, it may generally have a cylindrical shape, possibly with one or more indentations or protrusions to allow the painter to exert comfortable control over the device 100.

In the embodiment shown in FIGS. 1-13, the handle 10 is a single piece of material, such as steel, aluminum, or a plastic, that has a first section 14 that is vertically oriented, a second section 16 that is horizontally oriented, and a third section 18 that is also vertically oriented. The grip section 12 is inserted over a lower end of the first section 14 and secured using conventional means such as an adhesive or a threaded fastener. The handle 10 also includes an arm connector 22.

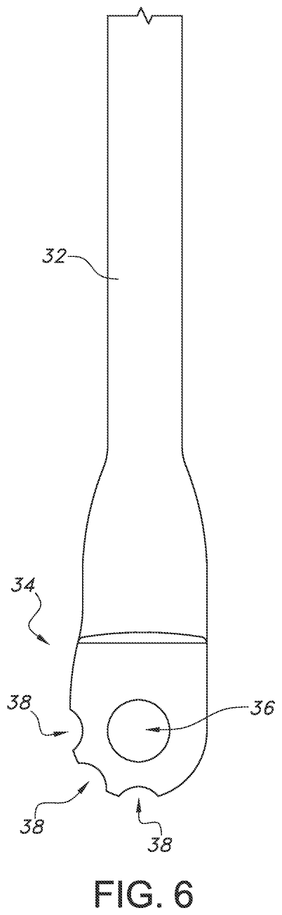

The roller arm 30 in this example includes a roller section 32 that is similar to a conventional roller and is an approximately straight and cylindrically shaped piece of material, such as steel, aluminum, or a plastic. The roller arm 30 also includes a handle connector 34. The handle connector 34, best shown in FIG. 6, includes an opening 36 and a number of slots 38.

The handle connector 34 and arm connector 22 are connected to one another using conventional means such as a cylindrical rod 24. The cylindrical rod 24 may secure the handle connector 34 and arm connector 22 in a number of conventional ways, for example, after the connection is made the cylindrical rod 23 may be welded in place, or it may be a threaded fastener that is threadedly secured in/to the arm connector 22 or a threaded connector such as a bolt that is secured by a nut.

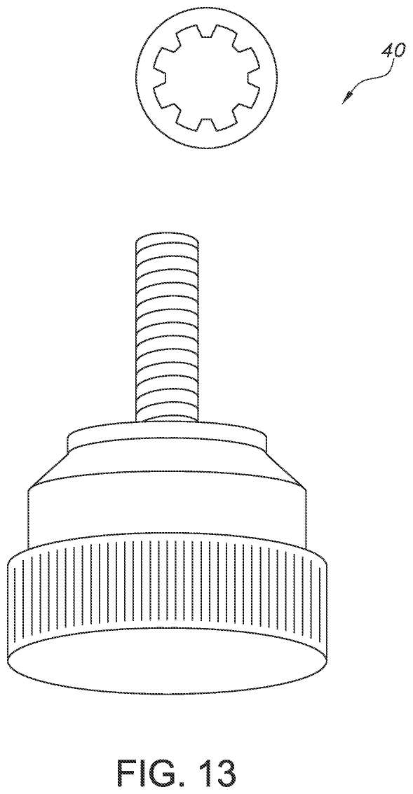

The handle 10 also includes an adjustment opening 26. An arm securing member 40 is adjustably extended through the opening 26 and in between one of the slots 38, pressing against the handle 10 at a point approximately opposite that of the opening 26. For example, the arm securing member 40 may be knob attached to a threaded fastener that is used in combination with a locking washer, as shown in FIG. 13. To adjust the arm 30 the arm securing member 40 is loosened so as to allow the user to move the arm 30 to a different position, after which the member 40 is reinserted through a separate notch 38 to secure the arm in a different orientation.

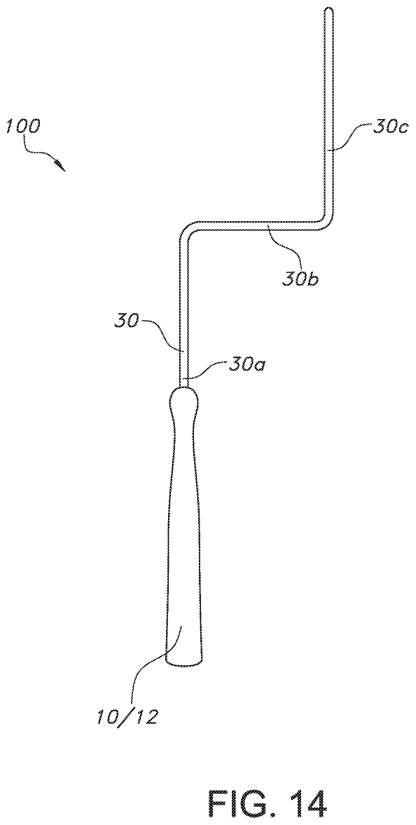

FIG. 14 shows a second embodiment in which the roller arm 30 has an approximately vertical orientation and is not adjustable. The handle 10 is a single element that is a grip handle 12 and that is constructed in a conventional manner. The roller arm 30 is a single piece having three sections that is inserted into and secured in the handle 10 and secured in conventional means such as by adhesives or threaded fasteners. The roller arm further includes a first arm section 30a that extends straight out from the handle 10, a second arm section 30b that extends away from the first section 30a in an approximately horizontal manner, and a third arm section 30c that extends upward in a largely vertical direction. The third arm section 30c is sized to securely attach to the roller cover C, likely in a conventional manner. One or more of the roller arm sections 30a, 30b, 30c, may be constructed as a part of the handle 10 rather than the roller arm 30. It is also possible that the handle 10 and cover arm 30 may be a single component, for example a molded component.

It is understood that the embodiments described herein are merely illustrative of the present invention. Variations in the construction of the roller frame device may be contemplated by one skilled in the art without limiting the intended scope of the invention herein disclosed and as defined by the following claims.

What is claimed is:

1: A roller frame device adapted to secure a roller cover, the roller frame device comprising:
A handle that is adjustably coupled to a roller arm, the roller arm adapted to support the roller cover in one or more positions, at least one of the one or more positions being an approximately vertically oriented alignment.

2: The roller frame of claim 1, further including a roller arm securing member that is adapted to adjustaby fix the roller arm in one of the one or more positions relative to the handle.

3: The roller frame device of claim 2, wherein the roller arm securing member is adapted to adjustaby fix the roller arm in a horizontally oriented alignment.

4: The roller frame device of claim 3, wherein the roller arm securing member is adapted to adjustaby fix the roller arm in an angled alignment that positions the roller cover in an orientation between a vertical orientation and a horizontal orientation.

5: The roller device of claim 4, the roller arm including a handle connector and the handle including an arm connector, and wherein the handle connector and arm connector and rotateably coupled to one another.

6: The roller device of claim 5, wherein the handle connector and arm connector are coupled together by a rod.

7: The roller device of claim 5, the roller arm further including one or more slots and the handle including an adjustment opening; and
wherein the roller arm securing member is configured to be inserted through the adjustment opening and into one of the slots to secure the roller arm in one of the one or more positions.

8: A roller frame device adapted to secure a roller cover, the roller frame device comprising:
a handle that is connected to a roller arm, the roller arm configured to secure the roller cover in an approximately vertical orientation.
